(19) United States
(12) Patent Application Publication
(10) Pub. No.: US 2026/0082364 A1
(43) Pub. Date: Mar. 19, 2026

(54) ESTIMATING DEVICE, ESTIMATING SYSTEM, ESTIMATING METHOD, AND RECORDING MEDIUM

(71) Applicant: Panasonic Intellectual Property Management Co., Ltd., Osaka (JP)

(72) Inventors: Nobuyuki SHIRAKI, Hokkaido (JP); Takeshi NAKAYAMA, Hyogo (JP); Shoichi IIZUKA, Osaka (JP); Naoki HONMA, Iwate (JP); Takumi SHIMOFUSA, Iwate (JP); Kentaro KIKUTA, Iwate (JP)

(21) Appl. No.: 19/323,508

(22) Filed: Sep. 9, 2025

(30) Foreign Application Priority Data
Sep. 10, 2024 (JP) 2024-156941
Aug. 8, 2025 (JP) 2025-133663

(51) Int. Cl. H04W 64/00; H04L 25/02

(52) U.S. Cl. CPC H04W 64/006; H04L 25/0204

(57) ABSTRACT

An estimating device: generates a multicarrier signal; causes a transmission antenna including M transmission antenna elements to transmit the multicarrier signal; measures, for a first period equivalent to a cycle derived from an activity of a moving body, a reception signal which is received by N reception antenna elements included in L reception antennas and includes a reflected signal of the multicarrier signal transmitted from the M transmission antenna elements and reflected or scattered by the moving object; calculates, for each of subcarriers, complex transfer functions each indicating a propagation characteristic between the M transmission antenna elements and the N reception antenna elements, using the reception signal measured in the first period; calculates a correlation matrix based on the complex transfer functions; calculates subcarrier phase offsets from an imaginary component of the moving object information; and estimates a direction from the estimating device to the moving object.

### CROSS REFERENCE TO RELATED APPLICATION

The present application is based on and claims priority of Japanese Patent Application No. 2024-156941 filed on Sep. 10, 2024 and Japanese Patent Application No. 2025-133663 filed on Aug. 8, 2025. The entire disclosure of the above-identified application, including the specification, drawings and claims is incorporated herein by reference in its entirety.

### FIELD

The present disclosure relates to an estimating device, an estimating system, an estimating method, a recording medium, and so on, for estimating the direction or position of a moving object by using radio signals.

### BACKGROUND

A method that uses radio signals is being considered as a method for knowing the position of a person (see for example, Patent Literature (PTL) 1 to 5). PTL 1, 2, and 3 disclose techniques of estimating the position and state of a person that is a detection target by analyzing a component including a Doppler shift using difference calculation. PTL 4 and 5 disclose Doppler sensors that use orthogonal frequency division multiplexing (OFDM) signals.

### CITATION LIST

### Patent Literature

PTL 1: Japanese Unexamined Patent Application Publication No. 2015-117972
PTL 2: Japanese Unexamined Patent Application Publication No. 2017-129558
PTL 3: Japanese Unexamined Patent Application Publication No. 2018-008021
PTL 4: Japanese Unexamined Patent Application Publication No. 2012-088279
PTL 5: Japanese Unexamined Patent Application Publication No. 2012-137340

### Non Patent Literature

NPL 1: H. Yamada, M. Ohmiya, Y. Ogawa and K. Itoh, “Superresolution techniques for time-domain measurements with a network analyzer,” in IEEE Transactions on Antennas and Propagation, vol. 39, no. 2, pp. 177-183, February 1991

### SUMMARY

### Technical Problem

With the conventional methods, it is difficult to more accurately estimate the distance from the estimating device to a moving object and the direction from the estimating device to the moving object, etc.

### Solution to Problem

In order to achieve the above object, an estimating device according to one aspect of the present disclosure estimates a direction to a moving object, and includes: a transmission signal generator that generates a multicarrier signal obtained by modulating a plurality of subcarrier signals; a transmission antenna including M transmission antenna elements, where M is a natural number greater than or equal to 1; a transmitter that causes the transmission antenna to transmit the multicarrier signal by processing and outputting the multicarrier signal to the transmission antenna; L reception antennas including a total of N reception antenna elements, where L is a natural number greater than or equal to 1, and N is a natural number greater than or equal to 2; L receivers that measure, for a first period equivalent to a cycle derived from an activity of the moving object, a reception signal which is received by the N reception antenna elements and includes a reflected signal which is the multicarrier signal transmitted from the M transmission antenna elements that has been reflected or scattered by the moving object; a complex transfer function calculator that calculates, for each of a plurality of subcarriers to which the plurality of subcarrier signals correspond, a plurality of complex transfer functions each indicating a propagation characteristic between the M transmission antenna elements and the N reception antenna elements, using the reception signal measured by the L receivers in the first period; a correlation matrix calculator that calculates a correlation matrix based on the plurality of complex transfer functions calculated for each of the plurality of subcarriers; a moving object information calculator that calculates moving object information including a moving object component extracted from the correlation matrix; and an estimator that calculates, for each of the plurality of subcarriers, a subcarrier phase offset from an imaginary component of the moving object information, and estimates a direction from the estimating device to the moving object based on the subcarrier phase offsets calculated, the subcarrier phase offset being a phase offset component in a frequency direction that is included in a phase component of the complex transfer functions corresponding to the subcarrier.

It should be noted that these general and specific aspects may be implemented using a system, an integrated circuit, a computer program, or a computer-readable recording medium such as a CD-ROM, or any combination of an apparatus, a system, a method, an integrated circuit, a computer program, or a recording medium.

### Advantageous Effects

According to the present disclosure, it is possible to more accurately estimate the distance from the estimating device to a moving object, etc.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram illustrating an example of a configuration of an estimating device according to an embodiment of the present disclosure.

FIG. 2 is a schematic diagram illustrating the positional relationship between antenna elements of an estimating device according to an embodiment of the present disclosure and a living body.

FIG. 3 is a conceptual diagram of the phase slope for subcarrier number.

FIG. 4 is a schematic diagram illustrating the position of a living body and the relationship between the living body, a transmission antenna element, and a reception antenna element.

FIG. 5 is a flowchart illustrating the estimation process performed by the estimating device according to an embodiment of the present disclosure.

FIG. 6A is a block diagram illustrating an example of a configuration of an estimating device according to Variation 1 of an embodiment of the present disclosure.

FIG. 6B is a block diagram illustrating an example of a configuration of an estimating device according to Variation 1 of an embodiment of the present disclosure.

FIG. 7 illustrates simulation conditions of a simulation using an estimating method according to an embodiment of the present disclosure.

FIG. 8 illustrates the simulation environment of a simulation using an estimating method according to an embodiment of the present disclosure.

FIG. 9 illustrates frequency response imaginary components with respect to subcarrier number in a simulation using an estimating method according to an embodiment of the present disclosure.

FIG. 10 illustrates another simulation result of a simulation using the estimating method according to the embodiment.

### DESCRIPTION OF EMBODIMENTS

### (Underlying Knowledge Forming Basis of the Present Disclosure)

A method that uses radio signals is being considered as a method for knowing the position of a person.

For example, PTL 1 and 2 disclose transmitting a radio signal over a predetermined area, receiving, using antennas, the radio signal reflected by a detection target, and estimating a complex transfer function between transmission and reception antennas. A complex transfer function is a function including complex numbers representing a relationship between input and output, and represents propagation characteristics between transmission and reception antennas. The number of elements of the complex transfer function is equivalent to the product of the number of transmission antennas and the number of reception antennas. In addition, PTL 3 discloses estimating the posture of a living body by using a radar cross-section (RCS) calculated from received power, with the same configuration as in PTL 2. RCS is an index indicating the area of an object that reflected a transmission wave, and the RCS of a living body changes in various ways according to the living body's posture.

PTL 1 discloses a processing device that allows knowing the position or state of a person that is a detection target by analyzing a component including a Doppler shift using Fourier transform. More specifically, the processing device records the temporal change of an element of a complex transfer function, and Fourier-transforms the temporal waveform thereof. Through biological activity such as respiration or heartbeat, a living body such as a person exerts a small Doppler effect on the reflected wave reflected by the living body. Therefore, a component including a Doppler shift obtained from the reflected wave includes the influence of the living body. On the other hand, a component without a Doppler shift obtained from the reflected wave is not influenced by the living body. That is, a component that does not include a Doppler shift corresponds to a reflected wave from a fixed object or a direct wave between transmission and reception antennas. Specifically, the position or state of a person that is a detection target can be obtained by using a component included in a predetermined frequency range in a Fourier-transformed waveform.

PTL 2 discloses a method of recording a temporal change in an element of a complex transfer function, and extracting a component including a small Doppler shift including the influence of a living body by analyzing difference information of the temporal change. Specifically, by this method, it is possible to know the position or state of a person that is a detection target by using the difference information.

In contrast, PTL 3 discloses an OFDM Doppler radar that transmits a pulse using an OFDM signal, and detects a Doppler shift caused by a traveling body that is a target. Furthermore, PTL 4 discloses, with regard to an OFDM Doppler radar, a high-speed processing method that does not require Fourier transform.

Furthermore, PTL 4 and 5 disclose techniques for improving the accuracy of estimation of complex transfer functions between transmission and reception antennas, by transmitting an OFDM signal. PTL 4 discloses that received noise components can be reduced by averaging complex transfer functions on a subcarrier basis. PTL 5 discloses that received noise components can be reduced by selecting the subcarrier with the maximum received power.

However, in the methods in PTL 1, 2, and 3, non-modulated waves are transmitted, and thus it is difficult to make use of commercially available devices, and dedicated hardware is required. Specifically, it is not possible to use communication devices that are currently widely used, and thus a user needs to additionally provide dedicated hardware aside from an existing communication device.

Furthermore, in order to obtain sufficient accuracy with the methods in PTL 4 and 5, it is necessary to make pulses steep, which requires a wide frequency band. As such, the cost of hardware is more expensive compared to communication devices for public use.

In the technique in NPL 1, by transmitting and receiving signals having a plurality of frequencies using a measuring device such as a network analyzer, it is possible to estimate the time of flight (ToF) or distance, which can be computed from the ToF, between a transmission antenna and a reception antenna. As in a ranging sensor that uses a frequency modulated continuous wave (FMCW) radar, this makes use of the property in which, when two signals having different frequencies are transmitted at the same phase, the phase received by the reception antenna changes depending on the frequency difference between signals and the propagation distance between the antennas. The technique in NPL 1 improves resolution by performing ToF estimation using the multiple signal classification (MUSIC) method.

However, it is necessary for the transmission side and reception side to either operate with the same reference frequency or be synchronized with high accuracy, and thus applying this technique to household devices such as wireless LAN is difficult. Furthermore, only the distance between antennas can be estimated, and, for example, it is difficult to estimate the distance between the device and a living body that is not equipped with a special device.

The inventors developed an estimating device, etc., capable of more accurately estimating the position and the like of a living body.

An estimating device according to a first aspect of the present disclosure estimates a direction to a moving object, and includes: a transmission signal generator that generates a multicarrier signal obtained by modulating a plurality of subcarrier signals; a transmission antenna including M transmission antenna elements, where M is a natural number greater than or equal to 1; a transmitter that causes the transmission antenna to transmit the multicarrier signal by processing and outputting the multicarrier signal to the transmission antenna; L reception antennas including a total of N reception antenna elements, where L is a natural number greater than or equal to 1, and N is a natural number greater than or equal to 2; L receivers that measure, for a first period equivalent to a cycle derived from an activity of the moving object, a reception signal which is received by the N reception antenna elements and includes a reflected signal which is the multicarrier signal transmitted from the M transmission antenna elements that has been reflected or scattered by the moving object; a complex transfer function calculator that calculates, for each of a plurality of subcarriers to which the plurality of subcarrier signals correspond, a plurality of complex transfer functions each indicating a propagation characteristic between the M transmission antenna elements and the N reception antenna elements, using the reception signal measured by the L receivers in the first period; a correlation matrix calculator that calculates a correlation matrix based on the plurality of complex transfer functions calculated for each of the plurality of subcarriers; a moving object information calculator that calculates moving object information including a moving object component extracted from the correlation matrix; and an estimator that calculates, for each of the plurality of subcarriers, a subcarrier phase offset from an imaginary component of the moving object information, and estimates a direction from the estimating device to the moving object based on the subcarrier phase offsets calculated, the subcarrier phase offset being a phase offset component in a frequency direction that is included in a phase component of the complex transfer functions corresponding to the subcarrier.

With this, by analyzing the phase offset of signals corresponding to a plurality of subcarriers, it is possible to accurately estimate the direction from the estimating device to the living body based on the frequency characteristics for each subcarrier.

For example, a moving object radar that measures the position of a moving object can be realized by repurposing an existing communication device by using a multicarrier signal such as an OFDM signal as a transmission signal. For example, reception devices of multicarrier signals such as OFDM signals are already widely used as mobile phones, television broadcast reception devices, wireless LAN devices, and so on, and thus a moving object radar that measures the position of a moving object can be realized at a lower cost than when non-modulated signals are used.

An estimating device according to a second aspect of the present disclosure is the estimating device according to the first aspect, wherein the moving object information calculator extracts, as the moving object component, only a component in a specific frequency-domain corresponding to a variation component from a transformation matrix obtained by transforming the correlation matrix into a frequency domain.

With this, because it is possible to extract only the signal component corresponding to the variation component, the influence of unnecessary components can be reduced, and the accuracy of estimation of the direction to the moving object can be improved.

An estimating device according to a third aspect of the present disclosure is the estimating device according to the first aspect, wherein the moving object information calculator extracts, as the moving object component, only a component in a specific frequency-domain derived from movement of the moving object from a transformation matrix obtained by transforming the correlation matrix into a frequency domain.

With this, because it is possible to extract the signal component corresponding only to a component derived from movement of the moving object, the influence of unnecessary components can be reduced, and the accuracy of estimation of the direction to the moving object can be improved.

An estimating device according to a fourth aspect of the present disclosure is the estimating device according to the second aspect, wherein the specific frequency-domain includes only positive frequency components.

With this, by limiting to positive frequency components, it is possible to perform signal processing based on information on a specific frequency band derived from the moving object and improve the accuracy of the estimation process.

An estimating device according to a fifth aspect of the present disclosure is the estimating device according to the third aspect, wherein the specific frequency-domain includes only positive frequency components.

With this, by limiting to positive frequency components, it is possible to perform signal processing based on information on a specific frequency band derived from the moving object and improve the accuracy of the estimation process.

An estimating device according to a sixth aspect of the present disclosure is the estimating device according to the first aspect, wherein the estimator further: calculates a subcarrier phase slope from the imaginary component of the moving object information, the subcarrier phase slope being a phase slope of a signal spanning frequency components corresponding to the plurality of subcarriers; and estimates a distance of a propagation path from the transmission antenna to the L reception antennas via the moving object based on the subcarrier phase slope.

With this, by analyzing the phase slope of signals over a plurality of subcarriers, it is possible to accurately estimate the distance of the propagation path between the living body based on the frequency characteristics.

An estimating device according to a seventh aspect of the present disclosure is the estimating device according to any one of the first to sixth aspects, wherein the estimator estimates a direction from the L reception antennas to the moving object by calculating the subcarrier phase offset using any one of the following methods on the imaginary component of the moving object information of the correlation matrix: sinusoidal fitting; second-order differentiation; a MUltiple SIgnal Classification (MUSIC) method; a Capon method; Fast Fourier Transform (FFT); or Discrete Fourier Transform (DFT).

With this, by performing calculation using any one of the processing methods suitable for phase offset analysis, it is possible to perform high-precision estimation of the direction to the moving object based on the imaginary component of the complex transfer function.

An estimating system according to an eighth aspect of the present disclosure estimates a direction to a moving object, and includes: a transmission signal generator that generates a multicarrier signal obtained by modulating a plurality of subcarrier signals; a transmission antenna including M transmission antenna elements, where M is a natural number greater than or equal to 1; a transmitter that causes the transmission antenna to transmit the multicarrier signal by processing and outputting the multicarrier signal to the transmission antenna; L reception antennas including a total of N reception antenna elements, where L is a natural number greater than or equal to 1, and N is a natural number greater than or equal to 2; L receivers that measure, for a first period equivalent to a cycle derived from an activity of the moving object, a reception signal which is received by the N reception antenna elements and includes a reflected signal which is the multicarrier signal transmitted from the M transmission antenna elements that has been reflected or scattered by the moving object; a complex transfer function calculator that calculates, for each of a plurality of subcarriers to which the plurality of subcarrier signals correspond, a plurality of complex transfer functions each indicating a propagation characteristic between the M transmission antenna elements and the N reception antenna elements, using the reception signal measured by the L receivers in the first period; a correlation matrix calculator that calculates a correlation matrix based on the plurality of complex transfer functions calculated for each of the plurality of subcarriers; a moving object information calculator that calculates moving object information including a moving object component extracted from the correlation matrix; and an estimator that calculates, for each of the plurality of subcarriers, a subcarrier phase offset from an imaginary component of the moving object information, and estimates a direction from the transmission antenna or the L reception antennas to the moving object based on the subcarrier phase offsets calculated, the subcarrier phase offset being a phase offset component in a frequency direction that is included in a phase component of the complex transfer functions corresponding to the subcarrier.

With this, by analyzing the phase offset of signals corresponding to a plurality of subcarriers, it is possible to accurately estimate the direction from the estimating device to the living body based on the frequency characteristics for each subcarrier.

An estimating method according to a ninth aspect of the present disclosure is executed by an estimating device that estimates a distance to a moving object, and includes: generating a multicarrier signal obtained by modulating a plurality of subcarrier signals; causing the transmission antenna to transmit the multicarrier signal by processing and outputting the multicarrier signal to a transmission antenna including M transmission antenna elements, where M is a natural number greater than or equal to 1; measuring, for a first period equivalent to a cycle derived from an activity of the moving object, a reception signal which is received by N reception antenna elements included in L reception antennas and includes a reflected signal which is the multicarrier signal transmitted from the M transmission antenna elements that has been reflected or scattered by the moving object, where N is a natural number greater than or equal to 2, and L is a natural number greater than or equal to 1; calculating, for each of a plurality of subcarriers to which the plurality of subcarrier signals correspond, a plurality of complex transfer functions each indicating a propagation characteristic between a transmission antenna element and a reception antenna element in each of M×N combinations of each of the M transmission antenna elements and each of the N reception antenna elements, using the reception signal measured by the L receivers in the first period; calculating a correlation matrix based on the plurality of complex transfer functions calculated for each of the plurality of subcarriers; calculating moving object information including a moving object component extracted from the correlation matrix; calculating, for each of the plurality of subcarriers, a subcarrier phase offset from an imaginary component of the moving object information, the subcarrier phase offset being a phase offset component in a frequency direction that is included in a phase component of the complex transfer functions corresponding to the subcarrier; and estimating a direction from the estimating device to the moving object based on the subcarrier phase offsets calculated.

With this, by analyzing the phase offset of signals corresponding to a plurality of subcarriers, it is possible to accurately estimate the direction from the estimating device to the living body based on the frequency characteristics for each subcarrier.

A recording medium according to a tenth aspect of the present disclosure is a non-transitory computer-readable recording medium for use in a computer, the non-transitory computer-readable recording medium having recorded thereon a computer program for causing the computer to execute the estimating method according to the ninth aspect.

It should be noted that these generic and specific aspects may be implemented using a system, an integrated circuit, a computer program, or a computer-readable recording medium such as a CD-ROM, or any combination of an apparatus, a system, a method, an integrated circuit, a computer program, or a recording medium.

Hereinafter, exemplary embodiments of the present disclosure will be described in detail with reference to the Drawings. It should be noted that each of the exemplary embodiments described hereinafter illustrate a specific example of the present disclosure.

The numerical values, shapes, materials, elements, the arrangement and connection of the elements, steps, the processing order of the steps, etc., shown in the following exemplary embodiments are mere examples, and are therefore not intended to limit the present disclosure. Furthermore, among elements in the following exemplary embodiments, those not recited in any one of the independent claims defining the most generic concept of the present disclosure are described as optional elements making up a more preferable form. It should be noted that in the Specification and the Drawings, elements having substantially the same functional configuration are given the same reference sign in order to omit overlapping descriptions.

### EMBODIMENT

The embodiment describes a method for detecting a living body in a case where both the transmission antenna and the reception antenna include a single antenna element each, i.e., a single input single output (SISO) scheme. However, the method described in the present embodiment can similarly be applied to a multiple input multiple output (MIMO) scheme in which both the transmission antenna and the reception antenna are plurality, or a single input multiple output (SIMO) scheme or a multiple input single output (MISO) scheme in which either the transmission antenna or the reception antenna is plurality, by taking elements of a specific transmission and reception pair from among a plurality of combinations of transmission and reception antennas and performing processing similar to that of the SISO scheme.

### [Configuration of Estimating Device 101]

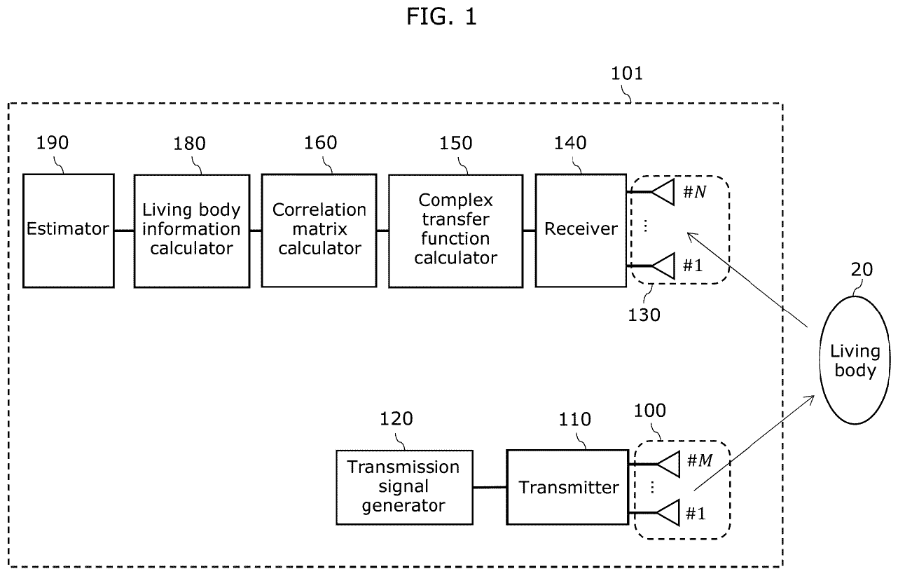

FIG. 1 is a block diagram illustrating an example of a configuration of an estimating device according to the embodiment.

Estimating device 101 illustrated in FIG. 1 includes transmission antenna 100, transmitter 110, transmission signal generator 120, reception antenna 130, receiver 140, complex transfer function calculator 150, correlation matrix calculator 160, living body information calculator 180, and estimator 190. Estimating device 101 estimates any one of the distance to living body 20, the direction to living body 20, or the position of living body 20. It should be noted that, as information related to living body 20, estimating device 101 may estimate the position of living body 20 in the target space, may estimate the posture of living body 20, may determine whether or not living body 20 is present in the target space, may identify living body 20 based on information (a complex transfer function matrix) registered in advance for each individual living body 20, or may estimate the movement of living body 20. Stated differently, estimating device 101 executes a process (estimation process) regarding estimation of the position, posture, presence, identification, movement, etc., regarding living body 20.

### [Transmission Antenna 100]

Transmission antenna 100 includes M transmission antenna elements. Here, M is a natural number greater than or equal to 1, and in the present embodiment, M is 1. As described above, the transmission antenna element transmits a multicarrier signal (transmission wave) generated by transmitter 110 to be described later.

### [Transmitter 110]

Transmitter 110 adds appropriate processing to the signal generated by transmission signal generator 120 (to be described later), to generate a transmission wave. The processing carried out here includes, for example, up-conversion in which the signal is converted from the intermediate frequency (IF) frequency band to the radio frequency (RF) frequency band, amplification in which the signal is amplified to the appropriate transmission level, etc. Then, transmitter 110 outputs the processed multicarrier signal to transmission antenna 100 to thereby cause transmission antenna 100 to transmit the multicarrier signal. With this, the multicarrier signal is transmitted from the M transmission antenna elements included in transmission antenna 100.

### [Transmission Signal Generator 120]

Transmission signal generator 120 generates a multicarrier signal obtained by modulating a plurality of subcarrier signals. More specifically, transmission signal generator 120 generates a plurality of subcarrier signals corresponding to a plurality of subcarriers having mutually different frequency bands, and generates a multicarrier signal by multiplexing the generated plurality of subcarrier signals. In the present embodiment, an example will be given in which transmission signal generator 120 generates, as a multicarrier signal, an OFDM signal of S subcarriers, which offers high frequency band utilization efficiency. Note that aside from generating an OFDM signal in which respective subcarriers are orthogonal, transmission signal generator 120 may generate other multicarrier signals such as a simple frequency division multiplexing (FDM) signal as long as it is a multicarrier signal obtainable by multicarrier modulation.

Furthermore, the signal generated by transmission signal generator 120 may be a signal that is shared with a signal used for communication such as wireless LAN. Stated differently, the transmission signal used for sensing living body 20 may be used exclusively for sensing living body 20, or may be used for both sensing living body 20 and for communicating information.

### [Reception Antenna 130]

Reception antenna 130 includes N reception antenna elements. Here, N is a natural number greater than or equal to 1, and in the present embodiment, N is 1. The N reception antenna elements receive a signal that was transmitted by the M transmission antenna elements and reflected by living body 20 (i.e., a reception signal (to be described later)).

Note that although the number of reception antenna elements included in reception antenna 130 is exemplified as a natural number greater than or equal to two in the present embodiment, reception antenna 130 may include a single reception antenna element, and in such cases, the number of transmission antenna elements included in transmission antenna 100 may be a natural number greater than or equal to two. Moreover, estimating device 101 may include a plurality of reception antennas 130. Specifically, estimating device 101 may include L (L is a natural number) reception antennas 130, and may include a total number of N reception antenna elements corresponding to each reception antenna 130. In this configuration, a case in which L=1 corresponds to a configuration of estimating device 101 including a single reception antenna 130 as described above.

### [Receiver 140]

Receiver 140 measures, for a first period equivalent to a cycle derived from an activity of living body 20, the reception signals that are received by the N reception antenna elements and include reflected signals which are the multicarrier signals transmitted from the M transmission antenna elements that have been reflected or scattered by living body 20. A cycle derived from the activity of living body 20 is a living body-derived cycle (living body fluctuation cycle) which is a time period greater than or equal to a half-cycle of any of the cycles of respiration, heartbeat, and body motion of living body 20.

Receiver 140 converts the high-frequency signal received by the N reception antenna elements into a low-frequency signal on which signal processing can be performed. Receiver 140 then demodulates the OFDM signal into S subcarrier signals (IQ symbols).

Receiver 140 further outputs, to complex transfer function calculator 150, all or a portion of the M×N sets of S subcarrier signals (IQ symbols) corresponding to each combination of the M transmission antenna elements and the N reception antenna elements. In the present embodiment, since M is 1 and N is 1, receiver 140 outputs all or a portion of one set of S subcarrier signals to complex transfer function calculator 150.

It should be noted that, receiver 140 may continue to measure the reception signals already received by reception antenna 130, and continuously or periodically transmit S low-frequency signals (IQ symbols).

Note that each of the signals received by the N reception antenna elements included in receiver 140 include a different phase rotation noise. Estimating device 101 may include a plurality of receivers 140.

### [Complex Transfer Function Calculator 150]

Complex transfer function calculator 150 calculates a complex transfer function using a plurality of reception signals measured in the first period. Specifically, complex transfer function calculator 150 may calculate, for each of a plurality of subcarriers to which the plurality of subcarrier signals correspond, a plurality of complex transfer functions indicating a propagation characteristic between a transmission antenna element and a reception antenna element in each of M×N combinations which are combinations of each of the M transmission antenna elements and each of the N reception antenna elements, or may calculate the plurality of complex transfer functions limited to one or more combinations among the M×N combinations.

It should be noted that the M×N combinations are all the obtainable one-to-one combinations between the M transmission antenna elements and the N reception antenna elements. In the present embodiment, hereinafter, only one combination of the M×N combinations will be used. It should be noted that when using one or more combinations, the noise resistance of the estimation result can be enhanced and accuracy improved by performing the subsequent processing in parallel.

In the present embodiment, complex transfer function calculator 150 calculates, using the S subcarrier signals, N×M×S sets of complex transfer functions indicating the propagation characteristics between each of the transmission antenna elements and each of the reception antenna elements, for each of the S subcarrier signals. In this way, receiver 140 may generate a complex transfer function matrix having N×M×S elements. It should be noted that the calculated complex transfer function matrix also includes reflected waves that did not arrive via living body 20, such as direct waves and reflected waves derived from a fixed object.

It should be noted that complex transfer function calculator 150 may constantly calculate the complex transfer function vector using each of the plurality of subcarrier signals output continuously or on a regular basis. By adopting this configuration, when estimating device 101 shares the hardware of a communication device, the complex transfer function vector that is normally calculated for use in processing by the communication device can also be used by estimating device 101.

In the present embodiment, complex transfer function calculator 150 calculates complex transfer function vector h(t) indicating a propagation characteristic between M transmission antenna elements and N reception antenna elements for the s-th subcarrier in the period of measurement time t, using the S subcarrier signals transmitted from receiver 140. Complex transfer function vector h(t) is expressed as in Equation 1 using the complex transfer function matrix.

$$\begin{matrix}[ Math . 1 ] & \\ h ( t ) = [ {h}_{1} ( t ) … {h}_{S} ( t ) ] & ( Equation 1 )\end{matrix}$$

### [Correlation Matrix Calculator 160]

Correlation matrix calculator 160 calculates the correlation matrix of each element of the complex transfer function vector h(t) calculated by complex transfer function calculator 150. In other words, correlation matrix calculator 160 calculates the correlation matrix based on the plurality of complex transfer functions calculated per subcarrier.

Hereinafter, the correlation matrix calculation will be described in detail using mathematical expressions. In the above-described complex transfer function vector h(t), the element corresponding to subcarrier s is expressed as hₛ. As shown in Equation 2, element hₛ is expressed as a sum of two propagation components that are functions of time t. The two propagation components include the direct wave component between transmission antenna 100 and reception antenna 130, and the propagation path component that is from transmission antenna 100, reflected off living body 20, and received by reception antenna 130.

$$\begin{matrix}[ Math . 2 ] & \\ {h}_{s} ( t ) = ( {h}_{sd} + {h}_{sv} {e}^{i {θ}_{v} ( t )} ) {e}^{i {θ}_{e} ( t )} & ( Equation 2 )\end{matrix}$$

Here, h_{sd} represents the direct wave component between transmission antenna 100 and reception antenna 130 that arrives not via living body 20, and hₛᵥe^{iθv(t)} represents the propagation path component that is from transmission antenna 100, reflected off living body 20, and received by reception antenna 130. θᵥ(t) is a phase component that varies in accordance with movement of living body 20, and represents time-dependent phase variation included in a signal reflected by living body 20. θₑ(t) represents a non-periodic, random phase error caused by a clock drift between the transmitter (transmission device) and receiver (reception device), or an internal inconsistency in the device. Here, i is an imaginary unit (i²=−1).

Next, the diagonal elements of correlation matrix r calculated based on the above-described complex transfer function vector h(t) can be expressed as in Equation 3. Among the diagonal elements, focusing on the element corresponding to subcarrier s (i.e., the s-th diagonal element), the random phase error component θₑ(t) can be negated (canceled), as shown in Equation 4.

$$\begin{matrix}[ Math . 3 ] & \\ \begin{matrix}r ( t ) = diag ( h ( t ) h * ( t ) ) \\ = ( \begin{matrix}{h}_{1} ( t ) {h}_{1}^{*} ( t ) \\ ⋮ \\ {h}_{S} ( t ) {h}_{S}^{*} ( t )\end{matrix} )\end{matrix} & ( Equation 3 )\end{matrix}$$

Here, each matrix from Equation 1 to Equation 3 includes antenna element directional components corresponding to the N antenna elements, but the following description will focus on the n-th reception antenna element, and computation for n-th reception antenna element will be described.

$$\begin{matrix}[ Math . 4 ] & \\ & ( Equation 4 )\end{matrix}$$

$$\begin{matrix}{h}_{s} ( t ) {h}_{s}^{*} ( t ) = ( {h}_{sd} + {h}_{sv} {e}^{i {θ}_{v} ( t )} ) {e}^{i {θ}_{e} ( t )} \times ( {h}_{sd}^{*} + {h}_{sv}^{*} {e}^{- i {θ}_{v} ( t )} ) {e}^{- i {θ}_{e} ( t )} \\ = {\vert {h}_{sd} \vert}^{2} + {h}_{sv} {h}_{sd}^{*} {e}^{- i {θ}_{v} ( t )} + {h}_{sv} {h}_{sd}^{*} {e}^{- i {θ}_{v} ( t )} + {\vert {h}_{sd} \vert}^{2}\end{matrix}$$

In Equation 3 and Equation 4, the asterisk (*) indicates the complex conjugate. In other words, this means the complex conjugate of the complex number (i.e., a complex number with an equal real part and an imaginary part opposite in sign). For example, the complex conjugate of a+bi is a−bi.

hₛₙ is the component corresponding to subcarrier s and reception antenna element n in the complex transfer function vector. h_{snd} is the component corresponding to the direct wave that arrives not via living body 20, and is the component corresponding to subcarrier s and reception antenna element n regarding the direct wave propagation path between transmission antenna 100 and reception antenna 130. Additionally, hₛₙᵥ corresponds to the component reflected by living body 20, and is the component corresponding to subcarrier s and reception antenna element n regarding the propagation path from transmission antenna 100 to reception antenna 130 via living body 20.

### [Living Body Information Calculator 180]

Living body information calculator 180 calculates living body information including a living body component extracted from the correlation matrix. Specifically, living body information calculator 180 successively records, in the time-series order in which the plurality of reception signals are measured, the diagonal element of the correlation matrix of the complex transfer function calculated by correlation matrix calculator 160, denoted as r, for each of the plurality of subcarriers. Living body information calculator 180 extracts, for each of the plurality of subcarriers, components induced by living body 20 from time-series data of diagonal elements of the correlation matrix measured during a first period, successively recorded in time series. Based on each of the extracted components, living body information calculator 180 calculates, for each of the plurality of subcarriers, a living body component transfer function vector expressed as a S×N dimensional matrix. Living body information calculator 180 is one example of a moving object information calculator that calculates moving object information as living body information.

Here, the living body component transfer function vector is obtained as a result of extracting the signal component corresponding to the reflected wave or scattered wave (living body component) included in the reception signal that passed via living body 20. This living body component is extracted based on fluctuations in diagonal elements in the correlation matrix successively recorded in time-series during the first period. Specific examples extraction methods include, for example, the Fourier transform disclosed in PTL 1, and a method using time-series difference information disclosed in PTL 2.

For example, with the method using Fourier transform, Fourier transform is performed on the diagonal elements of the correlation matrix recorded in time-series during the measurement period (i.e., the first period) using the measurement time (slow time) as the time axis, and only those components included in a specific frequency band are extracted. One example of such a specific frequency band is from 0.1 Hz to 3 Hz, which is the range in which effects from periodic activity of living body 20 such as breathing and heartbeat (i.e., biological activity) appear. With this process, it is possible to calculate a living body component transfer function vector for each of frequency components in that frequency band. Here, since signal components arriving via living body 20 change depending on the above-described hₛₙᵥ(t), by using Fourier transform to extract only the frequency components corresponding to biological activity, signal components related to hₛₙᵥ(t) can be efficiently extracted. With this, among terms in Equation 4, the second term and the third term are extracted.

Next, signal characteristics of the living body component transfer function matrix will be clarified through modeling. First, direct wave components h_{snd} received from a transmission antenna element by the n-th reception antenna element can be expressed as shown in Equation 5 using distance d_{nd} between the transmission antenna element and the n-th reception antenna element.

$$\begin{matrix}[ Math . 5 ] & \\ {h}_{snd} = {e}^{- j \frac{2 π}{{λ}_{s}} {d}_{nd}} & ( Equation 5 )\end{matrix}$$

The vital signals of living body 20, namely the displacement of the body surface, are modeled as shown in Equation 6. Here, a indicates the amount of displacement of the body surface of living body 20, ω indicates the angular frequency of the displacement of the body surface of living body 20, and φ indicates the initial phase of the displacement of the body surface of living body 20. Note that the displacement of the body surface of living body 20 results from periodic biological activity, mainly breathing and body oscillation.

$$\begin{matrix}[ Math . 6 ] & \\ & ( Equation 6 )\end{matrix}$$

$${h}_{v} ( t ) = {e}^{- j \frac{2 π}{{λ}_{k}} \{ {d}_{vn} + a cos ( ω t + φ ) \}} \approx {e}^{- j \frac{2 π}{{λ}_{s}} \{ {d}_{vn} + ( n - 1 ) Δ d sin {θ}_{DOA} + a cos ( ω t + φ ) \}}$$

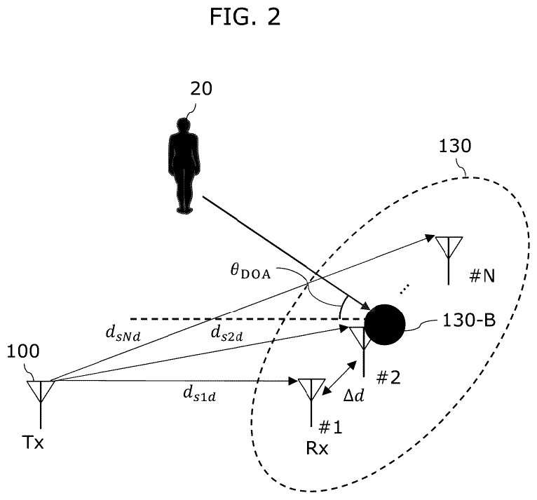

Here, the positional relationship between the transmission antenna element, the reception antenna element, and living body 20 is illustrated in FIG. 2. In FIG. 2, θ_{DOA} indicates the direction of living body 20 as seen from reference point (representative point) 130-B of the position of reception antenna 130.

Using the model in Equation 6, component hₛₙᵥ(t) arriving via living body 20 that is received by the n-th reception antenna element can be expressed as shown in Equation 7, using element spacing Δd between the 1^{st} reception antenna element, and θ_{DoA}.

$$\begin{matrix}[ Math . 7 ] & \\ {h}_{snv} ( t ) \approx {e}^{- j \frac{2 π}{{λ}_{s}} \{ {d}_{v 1} + ( n - 1 ) Δ d sin {θ}_{DOA} + a cos ( ω t + φ ) \}} & ( Equation 7 )\end{matrix}$$

Here, the signal component corresponding to the second and third terms in Equation 4 can be expressed as shown in Equation 8 by using Equation 5 and Equation 7.

$$\begin{matrix}[ Math . 8 ] & \\ & ( Equation 8 )\end{matrix}$$

$$\begin{matrix}{h}_{snv} ( t ) {h}_{snd}^{*} + {h}_{snd} {h}_{snv}^{*} ( t ) = {e}^{- j \frac{2 π}{{λ}_{s}} \{ ( {d}_{v 1} - {d}_{0 i} ) + ( n - 1 ) Δ d sin {θ}_{DOA} \}} {e}^{- j \frac{2 π}{{λ}_{s}} \{ a cos ( ω t + φ ) \}} \\ + {e}^{j \frac{2 π}{{λ}_{s}} \{ ( {d}_{v 1} - {d}_{0 i} ) + ( n - 1 ) Δ d sin {θ}_{DOA} \}} {e}^{- j \frac{2 π}{{λ}_{s}} \{ a cos ( ω t + φ ) \}}\end{matrix}$$

Furthermore, the complex sum term shown in Equation 8 (i.e., hₛₙᵥ(t)h_{snd}*+h_{snd}hₛₙᵥ*(t)) can be transformed as shown in Equation 10 by performing the substitution of Equation 9.

$$\begin{matrix}[ Math . 9 ] & \\ {e}^{- j \frac{2 π}{{λ}_{s}} \{ ( {d}_{v} - {d}_{0} ) + ( n - 1 ) Δ d sin {θ}_{DOA} \}} = p + jq & ( Equation 9 )\end{matrix}$$

$${h}_{snv} ( t ) {h}_{snd}^{*} + {h}_{snd} {h}_{snv}^{*} ( t ) = ( p + jq ) {e}^{- j \frac{2 π}{{λ}_{k}} \{ a cos ( ω t + φ ) \}} + ( p + jq ) {e}^{- j \frac{2 π}{{λ}_{k}} \{ a cos ( ω t + φ ) \}} \qquad ( Equation 10 )$$

The expression shown in Equation 10 can be approximately expanded as shown in Equation 11 by using the first-kind Bessel function Jₐ. Here, n represents n-th harmonic component, and since the first harmonic (n=±1) generally dominates in vital components, only the components of approximately n=0, ±1 are considered in the present embodiment.

$$\begin{matrix}[ Math . 10 ] & \\ & \end{matrix}$$

$${h}_{snv} ( t ) {{h}_{snd}}^{*} + {h}_{snd} {{h}_{snv}}^{*} ( t ) \approx ( p + jq ) \{ {\sum }_{n = - 1}^{1} {i}^{n} \cdot {J}_{n} ( \frac{2 π}{{λ}_{k}} a cos {φ}_{0} ) {e}^{in ω t} \} \cdot \{ {\sum }_{n = - 1}^{1} {J}_{n} ( - \frac{2 π}{{λ}_{k}} a sin {φ}_{0} ) {e}^{in ω t} \} + ( p - jq ) \{ {\sum }_{n = - 1}^{1} {i}^{n} \cdot {J}_{n} ( - \frac{2 π}{{λ}_{k}} a cos {φ}_{0} ) {e}^{in ω t} \} \cdot \{ {\sum }_{n = - 1}^{1} {J}_{n} ( \frac{2 π}{{λ}_{k}} a sin {φ}_{0} ) {e}^{in ω t} \} = 2 p + 4 p \cdot {J}_{1} ( \frac{2 π}{{λ}_{k}} a cos {φ}_{0} ) {J}_{1} ( \frac{2 π}{{λ}_{k}} a sin {φ}_{0} ) sin 2 ω t - 4 q \cdot {J}_{1} ( \frac{2 π}{{λ}_{k}} a cos {φ}_{0} ) cos ω t - 4 q \cdot {J}_{1} ( \frac{2 π}{{λ}_{k}} a sin {φ}_{0} ) sin ω t \qquad ( Equation 11 )$$

Here, by applying a Fourier transform to the time response shown in Equation 11, components in the frequency response become clear. More specifically, the first term is the DC (0 Hz) component, the second term is twice the vital frequency (2ω) component (second harmonic component), and the third and fourth terms appear as the vital frequency (ω) component. Stated differently, the real part of the vital frequency (ω) component appears as the following component.

$$- 4 q \cdot {J}_{1} ( \frac{2 π}{{λ}_{k}} a cos {φ}_{0} ) \qquad [ Math . 11 ]$$

The imaginary part appears as the following component.

$$- 4 q \cdot {J}_{1} ( \frac{2 π}{{λ}_{k}} a sin {φ}_{0} ) \qquad [ Math . 12 ]$$

Here, focusing on the real part of the vital frequency (ω) component, q is expressed as illustrated in Equation 12 by solving Equation 9 with respect to q. As a result, the coefficient part included in the third term on the right-hand side of Equation 11 (that is, the term corresponding to cos ωt) is transformed as illustrated in Equation 13 by using Equation 12.

$$\begin{matrix}[ Math . 13 ] & \\ q = sin [ - \frac{2 π}{{λ}_{k}} \{ ( {d}_{vn} - {d}_{0 i} ) + ( i - 1 ) Δ dsin {θ}_{DOA} \} ] & ( Equation 12 )\end{matrix}$$

$$- 4 q \cdot {J}_{1} ( \frac{2 π}{{λ}_{k}} a cos {φ}_{0} ) = - 4 {J}_{1} ( \frac{2 π}{{λ}_{k}} a cos {φ}_{0} ) sin [ - \frac{2 π}{{λ}_{k}} \{ ( {d}_{v 1} - {d}_{0 i} ) + ( i - 1 ) Δ dsin {θ}_{DOA} \} ] \qquad ( Equation 13 )$$

This (Equation 13) is organized as a function of subcarrier number k. Here, by using the relationship in Equation 14 regarding subcarrier frequency fₖ, Equation 13 can be transformed as illustrated in Equation 15. It should be noted that fₖ represents the frequency of k-th subcarrier, f_{w} represents the frequency band, and f_{c} represents the center frequency.

$$\begin{matrix}[ Math . 14 ] & \\ \frac{1}{{λ}_{k}} = \frac{{f}_{k}}{c} = \frac{1}{c} \{ ( {f}_{c} - \frac{{f}_{w}}{2} ) + \frac{{f}_{w}}{N} ( k - 1 ) \} & ( Equation 14 )\end{matrix}$$

$$- 4 q \cdot {J}_{1} ( \frac{2 π}{{λ}_{k}} a cos {φ}_{0} ) = - 4 {J}_{1} ( \frac{2 π}{{λ}_{k}} a cos {φ}_{0} ) \times sin [ - \frac{2 π {f}_{w}}{cM} \{ ( i - 1 ) Δ dsin {θ}_{DOA} + ( {d}_{v 1} - {d}_{0 i} ) \} k - \frac{2 π}{c} ( {f}_{c} - \frac{{f}_{w}}{2} - \frac{{f}_{w}}{M} \{ ( i - 1 ) Δ dsin {θ}_{DOA} + ( {d}_{v 1} - {d}_{0 i} ) \} ] \qquad ( Equation 15 )$$

Since Equation 15 obtained in this manner is a sinusoidal function with subcarrier number k as a variable, by introducing amplitude A, angular frequency B, and phase offset C of the sinusoid in order to succinctly express this function, Equation 15 can be modeled as illustrated in Equation 16.

$${r}_{q} ( s ) = Asin ( B s + C ) \qquad [ Math . 15 ]$$

$$A = - 4 {J}_{1} ( \frac{2 π}{{λ}_{k}} a cos {φ}_{0} )$$

$$B = - \frac{2 π {f}_{w}}{cM} \{ ( i - 1 ) Δ dsin {θ}_{DOA} + ( {d}_{v 1} - {d}_{0 i} ) \} \qquad ( Equation 16 )$$

$$C = - \frac{2 π}{c} ( {f}_{c} - \frac{{f}_{w}}{2} - \frac{{f}_{w}}{M} ) \{ ( i - 1 ) Δ dsin {θ}_{DOA} + ( {d}_{v 1} - {d}_{0 i} ) \}$$

Based on the above observations, it is clear that the measured living body component transfer function matrix can be expressed by a sinusoidal model such as Equation 16. In this sinusoidal model, by estimating the parameters A, B, and C of amplitude A, angular frequency B, and phase offset C, TOF can be calculated from angular frequency B, and DOA can be calculated from differences in phase offset C among the reception antenna elements.

Estimating device 101 estimates parameters A, B, and C by performing fitting between measured data r_{q} along the subcarrier frequency direction and sinusoidal model Asin(Bs+C). Here, estimating device 101 calculates a combination of parameters A, B, and C that minimizes evaluation function r_{fit} (see Equation 17) such that the error between measured data r_{q} and sinusoidal model Asin(Bs+C) is minimized in any given measurement range.

$$\begin{matrix}[ Math . 16 ] & \\ {r}_{fit} ( A , B , C ) = {\sum }_{s = 1}^{S} \{ {\vert lm ( {r}_{q} ( s , {f}^{′} ) {e}^{i ϕ} ) - Asin ( Bs + C ) \vert}^{2} \} & ( Equation 17 )\end{matrix}$$

Here, φ is a coefficient dependent on the initial phase of the vital signal, and is uniformly multiplied across all subcarriers. Therefore, estimator 190 can achieve improved estimation accuracy by setting φ so as to maximize the amplitude (absolute value) of imaginary component Im(r_{q}(s, f′)e^{iφ}) and thereby improve compatibility with the sinusoidal wave. Stated differently, estimator 190 identifies, based on Equation 17, coefficients A (amplitude), B (subcarrier phase slope), and C (phase shift) so as to minimize the error (sum of squared differences) between the measured data (frequency response imaginary components) and the sinusoidal model. In this way, estimator 190 can quantify the sinusoidal structure included in vital component r_{q}, and execute an estimation process regarding subsequent estimation targets using the quantification result.

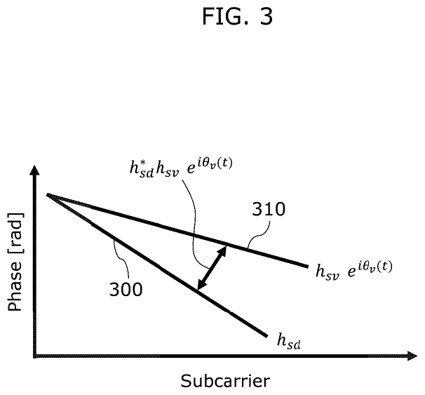

FIG. 3 is a conceptual diagram of the phase slope for subcarrier number s in Equation 3. As illustrated in FIG. 3, the phase changes as the frequency of the subcarrier increases, and the slope is different between direct wave component h_{sd} and reflected wave component hₛᵥ that arrives via living body 20. The imaginary component of complex conjugate product h*_{sd}hₛᵥ is the remaining component after subtracting subcarrier phase slope 300 of direct wave component h_{sd} from subcarrier phase slope 310 of reflected wave component hₛᵥ. That is, the distance estimation result based on complex conjugate product h*_{sd}hₛᵥ is a value obtained by subtracting the distance of the direct propagation path between transmission antenna 100 and reception antenna 130 from the distance of the propagation path from transmission antenna 100 to reception antenna 130 through living body 20. Therefore, estimator 190 can estimate the total propagation path distance of a signal transmitted from transmission antenna 100 and arriving at reception antenna 130 via living body 20 by adding the known distance based on the direct wave obtained from the physical positions of transmission antenna 100 and reception antenna 130.

Here, total propagation path distance dv is calculated using estimated distance d_{TOF} based on complex conjugate product h*_{ad}hₛᵥ and distance da between the transmission device and the reception device that is based on direct wave component h_{sd} according to Equation 10 and Equation 11 (to be described later). Note that in the present embodiment, distance d_{d} between the transmission device and the reception device may be a known value or an estimated value using a known method.

Here, subcarrier phase slope means the phase change rate of a signal being measured over frequency components corresponding to a plurality of subcarriers, i.e., the phase slope. This reflects phase changes that arise due to differences in propagation distance to the object or arrival time, and is an indicator used for object distance estimation, etc.

$$\begin{matrix}[ Math . 17 ] & \\ {d}_{TOF} = B ( S - 1 ) / ( {k}_{max} - {k}_{min} ) & ( Equation 18 )\end{matrix}$$

$$\begin{matrix}[ Math . 18 ] & \\ {d}_{v} = {d}_{TOF} + {d}_{d} & ( Equation 19 )\end{matrix}$$

Here, Kₘₐₓ represents the wave number of the maximum frequency in the used subcarriers, and Kₘᵢₙ represents the wave number of the minimum frequency in the used subcarriers.

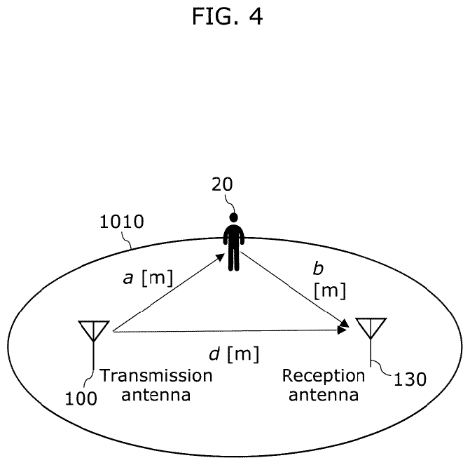

FIG. 4 is a schematic diagram illustrating the positional relationship between the living body, the transmission antenna element (transmission antenna 100), and the reception antenna element (reception antenna 130), and illustrating the position of living body 20 which is limited based on a third distance. Distance dv shown in Equation 19 corresponds to the sum of first distance a between transmission antenna 100 and living body 20 and second distance b between living body 20 and reception antenna 130, that is, the third distance, in FIG. 4.

Distance da corresponds to distance d between transmission antenna 100 and reception antenna 130. Estimator 190 estimates the third distance that is the sum of first distance a between transmission antenna 100 and living body 20 and second distance b between living body 20 and reception antenna 130, by using the correlation matrix calculated for each of the plurality of subcarriers. In this way, estimator 190 can estimate that living body 20 is located on the circumference of ellipse 1010 which has the positions of transmission antenna 100 and reception antenna 130 as foci. It should be noted that estimator 190 may use three or more pairs of transmission antenna 100 and reception antenna 130 to estimate a plurality of third distances, and may estimate the position of living body 20 based on intersections of a plurality of ellipses obtained from each of the plurality of third distances.

Next, estimator 190 can estimate direction of arrival θ_{DOA} based on the difference in phase offset C between each reception antenna element of reception antenna 130, as shown in Equation 16. Hereinafter, in a representative example, when focusing on the combination of reception antenna elements #1 and #n, phase offset difference ΔCₙ₁ is expressed by Equation 20.

$$\begin{matrix}[ Math . 19 ] & \\ Δ {C}_{n 1} = - \frac{2 π}{c} ( {f}_{c} - \frac{{f}_{w}}{2} - \frac{{f}_{w}}{M} ) ( Δ dsin {θ}_{D O A} + {d}_{01} - {d}_{0 n} ) & ( Equation 20 )\end{matrix}$$

Estimator 190 can determine direction of arrival θ_{DOAn1} as shown in Equation 21 below, by transforming the above-described Equation 20 with respect to θ_{DOAn1}, based on the combination of reception antenna elements #1 and #n.

$$\begin{matrix}[ Math . 20 ] & \\ {θ}_{DOAn 1} = - {sin}^{- 1} [ \frac{1}{Δ d} ( \frac{c Δ {C}_{21}}{2 π ( {f}_{c} - \frac{{f}_{w}}{2} - \frac{{f}_{w}}{M} )} - ( {d}_{0 n} - {d}_{01} ) ) ] & ( Equation 21 )\end{matrix}$$

In this manner, estimator 190 can calculate a plurality of directions of arrival θ_{DOA} for arbitrary combinations of a plurality of reception antenna elements based on Equation 21. An integrated θ_{DOA} may be estimated by performing statistical processing such as average value or median value processing on these directions of arrival θ_{DOA}. With this, the reliability of the estimation result of the direction of arrival can be increased.

### [Operation of Estimating Device 101]

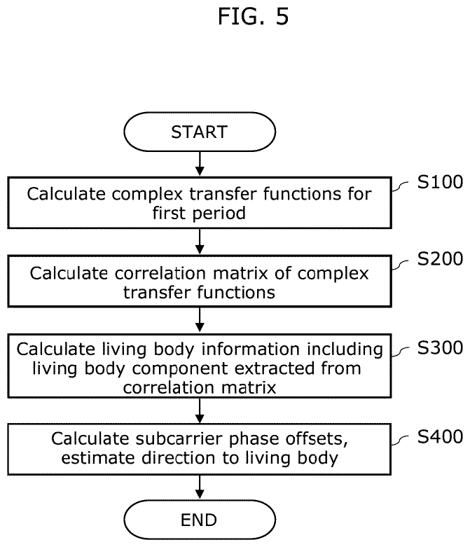

The operation in the estimation process by estimating device 101 configured in the above-described manner will be described with reference to FIG. 5. FIG. 5 is a flowchart illustrating the estimation process executed by estimating device 101 according to the embodiment.

Estimating device 101 calculates, based on a measurement of the reception signal during the first period, a plurality of complex transfer functions for each of a plurality of subcarriers (S100).

Next, estimating device 101 calculates a correlation matrix based on the complex transfer functions calculated for each of the subcarriers (S200).

Next, estimating device 101 calculates living body information including a living body component extracted from the correlation matrix (S300).

Lastly, estimating device 101 calculates, from the imaginary component of the living body information, for each of a plurality of subcarriers, a subcarrier phase offset which is a phase offset component in the frequency direction that is included in the phase component of the complex transfer functions corresponding to that subcarrier, and estimates the direction from estimating device 101 to living body 20 based on the calculated subcarrier phase offsets (S400).

Note that details of the processing for each step are omitted as they have already been described.

### Advantageous Effects, Etc

Estimating device 101 according to the present embodiment estimates the distance to living body 20. Estimating device 101 includes transmission signal generator 120, transmission antenna 100, transmitter 110, reception antenna 130, receiver 140, complex transfer function calculator 150, correlation matrix calculator 160, living body information calculator 180, and estimator 190. Transmission signal generator 120 generates a multicarrier signal obtained by modulating a plurality of subcarrier signals. Transmission antenna 100 includes M (M is a natural number greater than or equal to 1) transmission antenna elements. Transmitter 110 processes the multicarrier signal and outputs it to transmission antenna 100 to thereby cause transmission antenna 100 to transmit the multicarrier signal. Reception antenna 130 includes N (N is a natural number greater than or equal to 1) reception antenna elements. Receiver 140 measures, for a first period equivalent to a cycle derived from an activity of living body 20, the reception signals that are received by the N reception antenna elements and include reflected signals which are the multicarrier signals transmitted from the M transmission antenna elements that have been reflected or scattered by living body 20. Complex transfer function calculator 150 calculates, for each of a plurality of subcarriers to which the plurality of subcarrier signals correspond, a plurality of complex transfer functions each indicating a propagation characteristic between the M transmission antenna elements and the N reception antenna elements, using the reception signal measured by receiver 140 in the first period. Correlation matrix calculator 160 calculates the correlation matrix based on the plurality of complex transfer functions calculated per subcarrier. Living body information calculator 180 calculates living body information including a living body component extracted from the correlation matrix. Estimator 190 calculates, from the imaginary component of the living body information, for each of a plurality of subcarriers, a subcarrier phase offset which is a phase offset component in the frequency direction that is included in the phase component of the complex transfer functions corresponding to that subcarrier, and estimates the direction from estimating device 101 to living body 20 based on the calculated subcarrier phase offsets.

With this, by analyzing the phase offset of signals corresponding to a plurality of subcarriers, it is possible to accurately estimate the direction from estimating device 101 to living body 20 based on the frequency characteristics for each subcarrier.

In estimating device 101 according to the present embodiment, living body information calculator 180 extracts, as the living body component, only a component in a specific frequency-domain derived from movement of living body 20 from a transformation matrix obtained by transforming the correlation matrix into a frequency domain.

With this, because it is possible to extract only the signal component corresponding to the variation component, the influence of unnecessary components can be reduced, and the accuracy of estimation of the distance to living body 20 can be improved.

In estimating device 101 according to the present embodiment, living body information calculator 180 extracts, as the living body component, only a component in a specific frequency-domain derived from movement of living body 20 from a transformation matrix obtained by transforming the correlation matrix into a frequency domain.

With this, because it is possible to extract the signal component corresponding only to a component derived from movement of living body 20, the influence of unnecessary components can be reduced, and the accuracy of estimation of the distance to living body 20 can be improved.

In estimating device 101 according to the present embodiment, the specific frequency-domain includes only positive frequency components.

With this, by limiting to positive frequency components, it is possible to perform signal processing based on information on a specific frequency band derived from living body 20 and improve the accuracy of the estimation process.

In estimating device 101 according to the present embodiment, estimator 190 further calculates a subcarrier phase slope from the imaginary component of the living body information. Here, the subcarrier phase slope is a phase slope of a signal spanning frequency components corresponding to the plurality of subcarriers.

Estimator 190 estimates the distance of a propagation path from transmission antenna 100 to reception antenna 130 via living body 20 based on the subcarrier phase slope.

With this, by analyzing the phase slope of signals over a plurality of subcarriers, it is possible to accurately estimate the distance of the propagation path between living body 20 based on the frequency characteristics.

In estimating device 101 according to the present embodiment, estimator 190 estimates a direction from L reception antennas 130 to living body 20 by calculating the subcarrier phase slope using any one of the following methods on the imaginary component of the living body component of the correlation matrix: sinusoidal fitting; second-order differentiation; a MUltiple SIgnal Classification (MUSIC) method; a Capon method; Fast Fourier Transform (FFT); or Discrete Fourier Transform (DFT).

With this, by performing calculation using any one of the processing methods suitable for phase slope analysis, it is possible to perform high-precision estimation of the direction to living body 20 based on the imaginary component of the complex transfer function.

### Variation 1

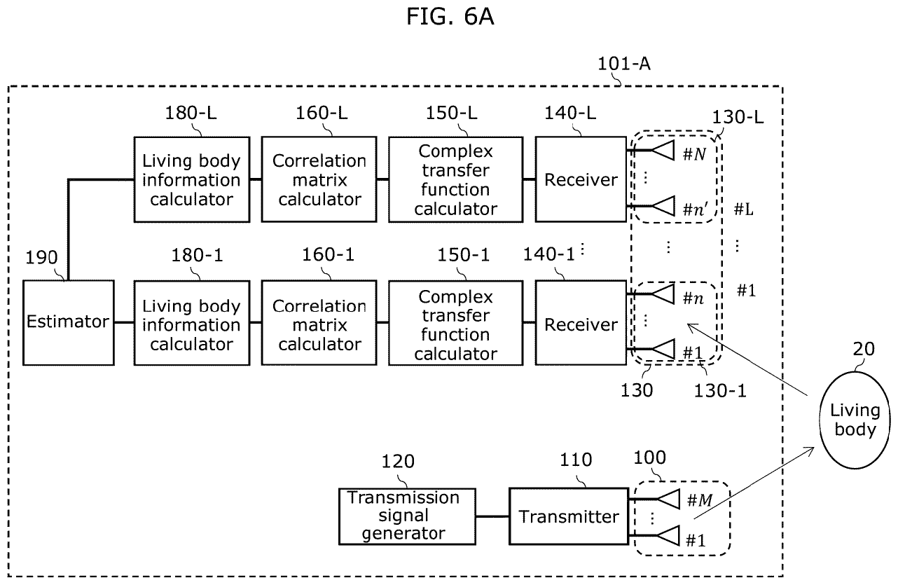

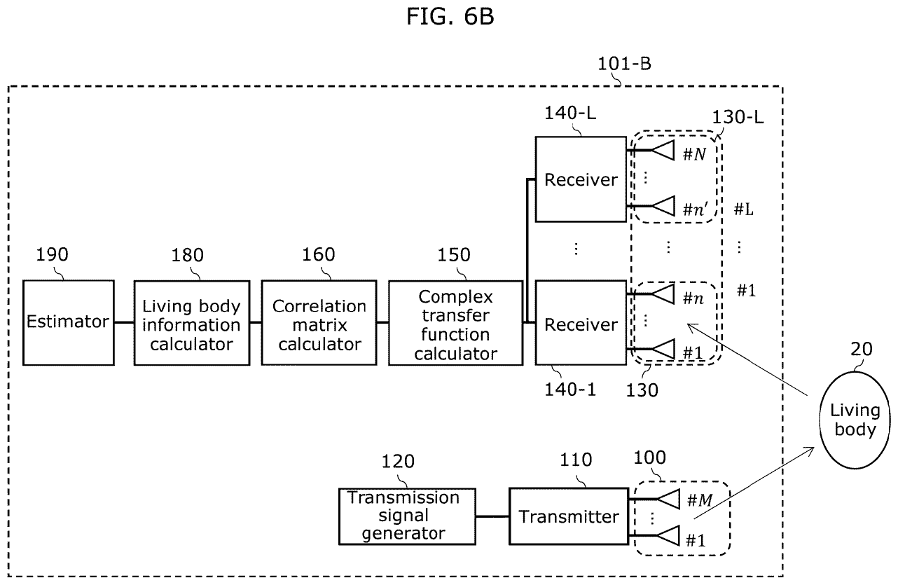

In the present embodiment, reception antenna 130 includes N reception antenna elements, and receiver 140 includes one, but this example is non-limiting. As illustrated in FIG. 6A, estimating device 101-A may include L (L is a natural number greater than or equal to 2) reception antennas 130-1 to 130-L and L receivers 140-1 to 140-L.

Each of reception antennas 130-1 to 130-L may be connectable to any given natural number of reception antenna elements. The total number of reception antenna elements connected to these L reception antennas is N (N is a natural number greater than or equal to L). Stated differently, estimating device 101-A according to the present configuration includes two or more reception antennas and two or more reception antenna elements.

As illustrated in FIG. 6A, estimating device 101-A includes, in one-to-one correspondence with receivers 140-1 to 140-L, complex transfer function calculators 150-1 to 150-L, correlation matrix calculators 160-1 to 160-L, and living body information calculators 180-1 to 180-L. Stated differently, the signals of receivers 140-1 to 140-L may be processed in parallel.

In contrast, as illustrated in FIG. 6B, estimating device 101-B may be configured to integrate L reception signals received by receivers 140-1 to 140-L into a matrix and collectively process them.

### Variation 2

In the present embodiment, coefficient B is calculated by calculating a combination of coefficients A, B, and C that minimizes the difference between sinusoidal model Asin(Bs+C) as illustrated in Equation 17 and vital component r_{q} in any given range. In contrast, as shown in Equation 10, the distance to living body 20 may be calculated by directly calculating only coefficient B. Here, when y is defined as Asin(Bs+C), coefficient B may be calculated by second-order differentiation of y in the direction of subcarrier number s, as shown in Equation 22.

$$\begin{matrix}[ Math . 21 ] & \\ - \frac{{y}^{″}}{y} = - \frac{- {AB}^{2} sin ( Bs + C )}{Asin ( Bs + C ) )} = {B}^{2} & ( Equation 22 )\end{matrix}$$

Here, B corresponds to the phase slope of the signal across subcarriers, and B>0. It is therefore possible to calculate coefficient B by taking the square root based on Equation 22. By using Equation 18 and Equation 19, the distance between estimating device 101 and living body 20 may be calculated based on coefficient B calculated using Equation 22.

### Variation 3

In the present embodiment, coefficient B is calculated by calculating a combination of coefficients A, B, and C that minimizes the error shown in Equation 17 in any given range. In contrast, a Fourier transform (FFT or DFT) or spectral estimation method (MUSIC method or Capon method) may be applied to vital component r_{q}, and coefficient B may be calculated from the peak in the obtained frequency spectrum.

Estimator 190 is capable of setting steering vector (mode vector) α_{DOA} based on Equation 23 when using the MUSIC method, for example. Direction of arrival θ_{DOA} of the reflected signal from living body 20 can be estimated by applying the MUSIC method or Capon method using this steering vector.

$$\begin{matrix}[ Math . 22 ] & \\ {a}_{DOA} = {e}^{- j \frac{2 π}{{λ}_{k}} \{ Δ d ( n - 1 ) sin θ + ( {d}_{0 n} - {d}_{01} ) \}} & ( Equation 23 )\end{matrix}$$

Estimator 190 can estimate direction of arrival θ and distance dh to living body 20 simultaneously by using the two-variable steering vector shown in Equation 24.

$$\begin{matrix}[ Math . 23 ] & \\ a ( {d}_{h} , θ ) = {e}^{j \frac{2 π}{{λ}_{s}} {d}_{h}} \times {e}^{- j \frac{2 π}{{λ}_{s}} \{ Δ d ( n - 1 ) sin θ + ( {d}_{0 n} - {d}_{01} ) \}} & ( Equation 24 )\end{matrix}$$

Here, distance dh represents the difference between a distance obtained based on a signal reflected by living body 20 and a distance obtained based on the direct wave from transmission antenna 100 to reception antenna 130.

### Variation 4

In the present embodiment, it was assumed that fitting processing is performed using the imaginary part in Equation 17; instead, the real part may be used as shown in Equation 25.

$$\begin{matrix}[ Math . 24 ] & \\ {r}_{fit} ( A , B , C ) = {\sum }_{s = 1}^{S} \{ {\vert Re ( {r}_{q} ( s , {f}^{′} ) {e}^{i ϕ} ) - Asin ( Bs + C ) \vert}^{2} \} & ( Equation 25 )\end{matrix}$$

### Variation 5

In the present embodiment, it was assumed that fitting processing is performed using the imaginary part in Equation 17; instead, comparison may be made of the sum of the square of the absolute value of each of the imaginary part and the real part as shown in Equation 26, and based on that difference r_{diff}, the component with larger value among the squares of the absolute values of the real part and the imaginary part may be selectively used as shown in Equation 27.

$$\begin{matrix}[ Math . 25 ] & \\ {r}_{diff} = {\sum }_{s = 1}^{S} \{ {\vert Re ( {r}_{q} ( s , {f}^{′} ) {e}^{i ϕ} ) \vert}^{2} \} - {\sum }_{s = 1}^{S} \{ {\vert lm ( {r}_{q} ( s , {f}^{′} ) {e}^{i ϕ} ) \vert}^{2} \} & ( Equation 26 )\end{matrix}$$

$$( Equation 27 )$$

$${r}_{fit} ( A , B , C ) = \{ \begin{matrix}{\sum }_{s = 1}^{S} \{ {\vert Re ( {r}_{q} ( s , {f}^{′} ) {e}^{i ϕ} ) - Asin ( Bs + C ) \vert}^{2} \} ( {r}_{diff} \geq 0 ) \\ {\sum }_{s = 1}^{S} \{ {\vert lm ( {r}_{q} ( s , {f}^{′} ) {e}^{i ϕ} ) - Asin ( Bs + C ) \vert}^{2} \} ( {r}_{diff} < 0 )\end{matrix}$$

### Variation 6

In the present embodiment, first measurement time t1 may be determined based on complex transfer function matrix h(t) corresponding to measurement time t. First measurement time t1 may be calculated based on the amplitude of complex transfer function matrix h(t), for example, at a time when the amplitude is maximum or minimum (peak or valley), at a time when a predetermined threshold is reached, or according to any arbitrary criterion.

### Variation 7

In the present embodiment, estimating device 101 is assumed to include reception antenna 130 including a plurality of reception antenna elements and transmission antenna 100 including a single transmission antenna element; however, transmission antenna 100 may include a plurality of transmission antenna elements and reception antenna 130 may include a single reception antenna element. Even in this case, based on the reversibility (bidirectional symmetry of the channel), the processing described in the embodiment can be applied as is. However, in this configuration, the direction of living body 20 to be estimated differs in that the direction of departure (DoD), i.e., the direction as seen from the transmission antenna element, is estimated.

### Variation 8

In the embodiment described above, a configuration for calculating a subcarrier phase slope from subcarrier phase offsets corresponding to a plurality of subcarriers and estimating the direction to the living body based on the calculated slope was described. However, the present disclosure is not limited to these embodiments, and a configuration may also be employed for estimating the direction to the living body directly using statistical processing or signal analysis methods based on values of a plurality of subcarrier phase offsets corresponding to each subcarrier without explicitly calculating the subcarrier phase slope. In this configuration, errors associated with deriving the phase slope can be reduced while effectively utilizing redundant information spanning a plurality of subcarriers, thereby enabling improvement in the accuracy of direction estimation.

### Variation 9

In the embodiment, instead of the aforementioned estimating device, the present disclosure may be implemented as an estimating system. More specifically, the estimating system includes: a terminal device having functions of a receiver and a transmitter; and a server.

In such cases, the terminal device includes a plurality of transmission antennas and reception antennas, and has functions for obtaining information related to reception and transmission, such as measurement and obtainment of reception signals and transmission of transmission signals during a predetermined measurement period, and transmitting this information to the server.

On the other hand, the server executes various processes described in the present specification, including calculation of the complex transfer function or correlation matrix, extraction of living body information, calculation of subcarrier phase offset, and estimation process, etc., based on the information about reception signals and transmission signals received from the terminal device.

By employing such a configuration, there is an advantage in reducing the load on the terminal device side while enabling centralized execution of advanced estimation processes and large-scale data analysis on the server side. By aggregating and managing the estimation process results at the server device, it becomes possible to integrate data from a plurality of terminal devices and perform centralized estimation.

Although an estimating device and an estimating method according to one aspect of the present disclosure have been described above based on embodiments and variations, the present disclosure is not limited to these embodiments. Various modifications to the exemplary embodiments that can be conceived by a person of ordinary skill in the art or forms obtained by combining elements of different embodiments, for as long as they do not depart from the essence of the present disclosure, are included in the scope of the present disclosure.

For example, although estimation of the distance or position of living body 20 is described as an example in the embodiment and variations, estimation is not limited to living body 20. Various moving objects (machines, etc.) whose activity imparts a Doppler effect on reflected waves in the case where a high-frequency signal is emitted are applicable.

Here, a simulation-based evaluation was performed to verify the effects according to the present embodiment. Hereinafter, the simulation will be described.

### [Simulation]

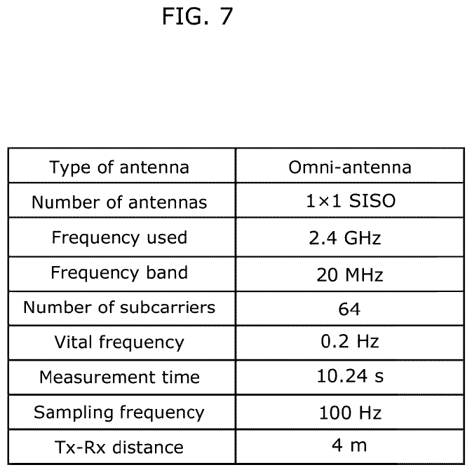

FIG. 7 illustrates the simulation conditions of a simulation using the estimating method according to the present embodiment.

As illustrated in FIG. 7, the transmission antenna and reception antenna are both single-element, omni-directional antenna SISO antennas. The transmission-reception distance is set to 4.0 m, and a signal in the 2.4 GHz band was transmitted from the transmission device. The channel measurement time was set to 10.24 seconds, the number of used subcarriers was 64, the frequency band was 20 MHz, the vital frequency was 0.2 Hz, and the sampling frequency was 100 Hz. Further, a random phase component is applied, and the signal to noise ratio (SNR) was set to 20 dB.

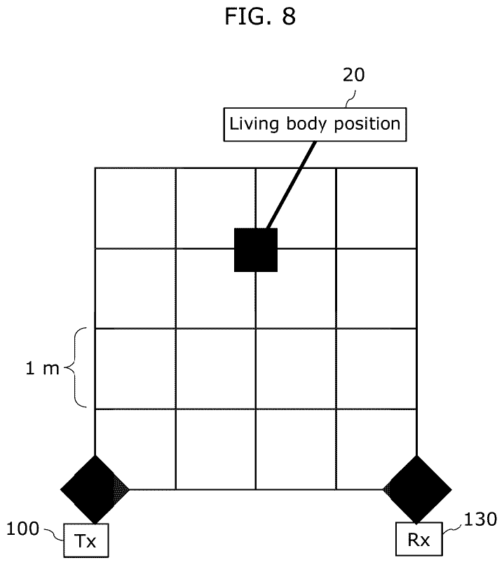

FIG. 8 illustrates the arrangement of antennas and a target in simulation. The transmission device position was set to (x, y)=(0, 0), the reception device position was set to (x, y)=(4, 0), and the target (subject) position was set to (x, y)=(2, 3).

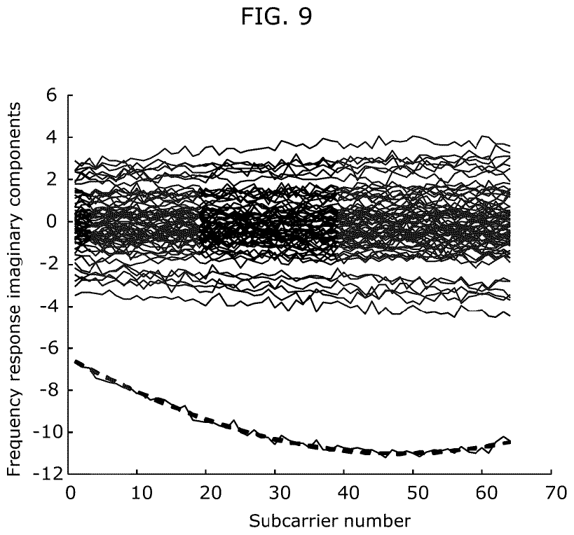

FIG. 9 is a conceptual diagram illustrating frequency response imaginary components with respect to subcarrier number. Non-vital components 200 of the frequency response imaginary components exhibit a linear trend with respect to subcarrier number, and transition near zero. In contrast, vital component 210 of the frequency response imaginary components exhibits a sinusoidal waveform, and fitting waveform 220 applied to vital component 210 of the frequency response imaginary components (fitting waveform of the vital component of the imaginary part of the frequency response) is illustrated traced along vital component 210 of the frequency response imaginary components. This confirms that the estimating method according to the present embodiment functions effectively and fitting is possible.

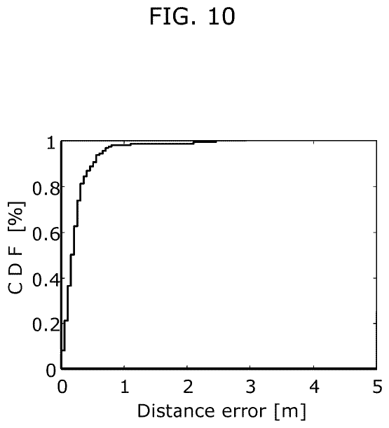

FIG. 10 illustrates another simulation result of a simulation using the estimating method according to the embodiment. FIG. 10 illustrates the cumulative distribution function (CDF) of distance error. In FIG. 10, the horizontal axis indicates distance error (unit: in), and vertical axis indicates CDF values with respect to distance error. In the estimating method proposed, the CDF value at distance error of 0.3 m is 0.75, which shows that high-precision living body position estimation is possible.

The present disclosure can not only be realized as a distance measuring sensor or positioning sensor including such characteristic elements, but can also be realized as an estimating method with steps corresponding to the characteristic elements included in the distance measuring sensor or positioning sensor. The present disclosure can also be realized as a computer program that causes a computer to execute each of the characteristic steps included in such a method. It goes without saying that such a computer program can be distributed via a non-transitory computer-readable recording medium such as CD-ROM or via a communication network such as the Internet.

### INDUSTRIAL APPLICABILITY

The present disclosure can be used for sensors and estimating methods that estimate the distance or position of a living body by using radio signals, and particularly, can be used for measuring instruments that measure the distance or position of a living body and a living body including a machine, home appliances that perform control according to the distance or position of a living body, and distance measuring sensors and positioning sensors mounted on surveillance devices that detect intrusion of a living body, and so on.

1. An estimating device that estimates a direction to a moving object, the estimating device comprising:
a transmission signal generator that generates a multicarrier signal obtained by modulating a plurality of subcarrier signals;
a transmission antenna including M transmission antenna elements, where M is a natural number greater than or equal to 1;
a transmitter that causes the transmission antenna to transmit the multicarrier signal by processing and outputting the multicarrier signal to the transmission antenna;
L reception antennas including a total of N reception antenna elements, where L is a natural number greater than or equal to 1, and N is a natural number greater than or equal to 2;
L receivers that measure, for a first period equivalent to a cycle derived from an activity of the moving object, a reception signal which is received by the N reception antenna elements and includes a reflected signal which is the multicarrier signal transmitted from the M transmission antenna elements that has been reflected or scattered by the moving object;
a complex transfer function calculator that calculates, for each of a plurality of subcarriers to which the plurality of subcarrier signals correspond, a plurality of complex transfer functions each indicating a propagation characteristic between the M transmission antenna elements and the N reception antenna elements, using the reception signal measured by the L receivers in the first period;
a correlation matrix calculator that calculates a correlation matrix based on the plurality of complex transfer functions calculated for each of the plurality of subcarriers;
a moving object information calculator that calculates moving object information including a moving object component extracted from the correlation matrix; and
an estimator that calculates, for each of the plurality of subcarriers, a subcarrier phase offset from an imaginary component of the moving object information, and estimates a direction from the estimating device to the moving object based on the subcarrier phase offsets calculated, the subcarrier phase offset being a phase offset component in a frequency direction that is included in a phase component of the complex transfer functions corresponding to the subcarrier.

2. The estimating device according to claim 1, wherein
the moving object information calculator extracts, as the moving object component, only a component in a specific frequency-domain corresponding to a variation component from a transformation matrix obtained by transforming the correlation matrix into a frequency domain.

3. The estimating device according to claim 1, wherein
the moving object information calculator extracts, as the moving object component, only a component in a specific frequency-domain derived from movement of the moving object from a transformation matrix obtained by transforming the correlation matrix into a frequency domain.

4. The estimating device according to claim 2, wherein
the specific frequency-domain includes only positive frequency components.

5. The estimating device according to claim 3, wherein
the specific frequency-domain includes only positive frequency components.

6. The estimating device according to claim 1, wherein
the estimator further:
calculates a subcarrier phase slope from the imaginary component of the moving object information, the subcarrier phase slope being a phase slope of a signal spanning frequency components corresponding to the plurality of subcarriers; and
estimates a distance of a propagation path from the transmission antenna to the L reception antennas via the moving object based on the subcarrier phase slope.

7. The estimating device according to claim 1, wherein
the estimator estimates a direction from the L reception antennas to the moving object by calculating the subcarrier phase offset using any one of the following methods on the imaginary component of the moving object information of the correlation matrix: sinusoidal fitting; second-order differentiation; a MUltiple SIgnal Classification (MUSIC) method; a Capon method; Fast Fourier Transform (FFT); or Discrete Fourier Transform (DFT).

8. An estimating system that estimates a direction to a moving object, the estimating system comprising:
a transmission signal generator that generates a multicarrier signal obtained by modulating a plurality of subcarrier signals;
a transmission antenna including M transmission antenna elements, where M is a natural number greater than or equal to 1;
a transmitter that causes the transmission antenna to transmit the multicarrier signal by processing and outputting the multicarrier signal to the transmission antenna;
L reception antennas including a total of N reception antenna elements, where L is a natural number greater than or equal to 1, and N is a natural number greater than or equal to 2;
L receivers that measure, for a first period equivalent to a cycle derived from an activity of the moving object, a reception signal which is received by the N reception antenna elements and includes a reflected signal which is the multicarrier signal transmitted from the M transmission antenna elements that has been reflected or scattered by the moving object;
a complex transfer function calculator that calculates, for each of a plurality of subcarriers to which the plurality of subcarrier signals correspond, a plurality of complex transfer functions each indicating a propagation characteristic between the M transmission antenna elements and the N reception antenna elements, using the reception signal measured by the L receivers in the first period;
a correlation matrix calculator that calculates a correlation matrix based on the plurality of complex transfer functions calculated for each of the plurality of subcarriers;
a moving object information calculator that calculates moving object information including a moving object component extracted from the correlation matrix; and
an estimator that calculates, for each of the plurality of subcarriers, a subcarrier phase offset from an imaginary component of the moving object information, and estimates a direction from the transmission antenna or the L reception antennas to the moving object based on the subcarrier phase offsets calculated, the subcarrier phase offset being a phase offset component in a frequency direction that is included in a phase component of the complex transfer functions corresponding to the subcarrier.

9. An estimating method executed by an estimating device that estimates a distance to a moving object, the estimating method comprising:
generating a multicarrier signal obtained by modulating a plurality of subcarrier signals;
causing the transmission antenna to transmit the multicarrier signal by processing and outputting the multicarrier signal to a transmission antenna including M transmission antenna elements, where M is a natural number greater than or equal to 1;
measuring, for a first period equivalent to a cycle derived from an activity of the moving object, a reception signal which is received by N reception antenna elements included in L reception antennas and includes a reflected signal which is the multicarrier signal transmitted from the M transmission antenna elements that has been reflected or scattered by the moving object, where N is a natural number greater than or equal to 2, and L is a natural number greater than or equal to 1;
calculating, for each of a plurality of subcarriers to which the plurality of subcarrier signals correspond, a plurality of complex transfer functions each indicating a propagation characteristic between a transmission antenna element and a reception antenna element in each of M×N combinations of each of the M transmission antenna elements and each of the N reception antenna elements, using the reception signal measured by the L receivers in the first period;
calculating a correlation matrix based on the plurality of complex transfer functions calculated for each of the plurality of subcarriers;
calculating moving object information including a moving object component extracted from the correlation matrix;
calculating, for each of the plurality of subcarriers, a subcarrier phase offset from an imaginary component of the moving object information, the subcarrier phase offset being a phase offset component in a frequency direction that is included in a phase component of the complex transfer functions corresponding to the subcarrier; and
estimating a direction from the estimating device to the moving object based on the subcarrier phase offsets calculated.

10. A non-transitory computer-readable recording medium for use in a computer, the non-transitory computer-readable recording medium having recorded thereon a computer program for causing the computer to execute the estimating method according to claim 9.
